(19) United States
(12) Patent Application Publication
(10) Pub. No.: US 2024/0371228 A1
(43) Pub. Date: Nov. 7, 2024

(54) GAMING DEVICE INCLUDING A HINGE ASSEMBLY FOR A DOOR

(71) Applicant: Aristocrat Technologies, Inc., Las Vegas, NV (US)

(72) Inventors: Kiran Dundaraddi, Las Vegas, NV (US); Brian Goldstein, Las Vegas, NV (US)

(21) Appl. No.: 18/584,586

(22) Filed: Feb. 22, 2024

Related U.S. Application Data
(60) Provisional application No. 63/500,196, filed on May 4, 2023.

(51) Int. Cl. G07F 9/10; G07F 17/32; G07F 17/34

(52) U.S. Cl. CPC G07F 9/10; G07F 17/3216; G07F 17/34

(57) ABSTRACT

A gaming device includes a cabinet defining an internal cavity therein, a door sized to cover at least a portion of the internal cavity, and a hinge assembly removably coupling the door to the cabinet. The hinge assembly includes a hinge body that includes a first section coupled to the cabinet by a pivot coupling and extending radially outward from the pivot coupling. The hinge body further includes a second section connected to the first section, where the second section contains a slot for receiving at least a portion of the door therein.

### CROSS-REFERENCE TO RELATED APPLICATIONS

This application claims priority to U.S. Provisional Application No. 63/500,196, filed May 4, 2023, the contents and disclosure of which are hereby incorporated by reference in their entirety.

### TECHNICAL FIELD

The field of disclosure relates generally to electronic gaming devices, and more particularly, to a gaming device having a cabinet door and a hinge assembly for the cabinet door.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming device is provided. The gaming device includes a cabinet defining an internal cavity therein, a door sized to cover at least a portion of the internal cavity, and a hinge assembly removably coupling the door to the cabinet. The hinge assembly includes a hinge body that includes a first section coupled to the cabinet by a pivot coupling and extending radially outward from the pivot coupling. The hinge body further includes a second section connected to the first section, where the second section contains a slot for receiving at least a portion of the door therein.

In another aspect, a hinge assembly for removably coupling a door to a cabinet of a gaming device is provided. The hinge assembly includes a pivot coupling and a hinge body that includes a first section configured to be coupled to the cabinet by the pivot coupling, the first section extending radially outward from the pivot coupling. The hinge body further includes a second section connected to the first section, wherein the second section contains a slot sized to receive at least a portion of the door therein.

In yet another aspect, a method of removably coupling a door to a cabinet of a gaming machine is provided. The method includes positioning a hinge assembly to face exterior to the cabinet, the hinge assembly including a hinge body including a first section coupled to the cabinet by a pivot coupling and extending radially outward from the pivot coupling. The hinge body further including a second section connected to the first section, the second section contains a slot. The method further includes sliding the door into the slot and pivoting the door to rotate the hinge body and close the door on the cabinet.

### BRIEF DESCRIPTION OF THE DRAWINGS

FIG. 1 is an exemplary diagram showing several gaming machines networked with various gaming-related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a perspective view of a gaming device according to an embodiment of the present disclosure and similar to the EGMs shown in FIG. 1, showing a main door of the gaming device in a closed position.

FIG. 5 is another perspective view of the gaming device shown in FIG. 4 with the door in an open position.

FIG. 6 is another perspective view of the gaming device shown in FIG. 4 with the door decoupled and removed from a cabinet of the gaming device.

FIG. 7 is a cross section of a portion of the gaming device shown in FIG. 4 with the door in the open position.

FIG. 8 is a perspective view of the door and hinge assembly of the gaming device shown in FIG. 4 with the door in the closed position and the hinge assembly in a retracted position.

FIG. 9 is a perspective view of the door and hinge assembly shown in FIG. 8 with the door in the open position and the hinge assembly in an extended position.

FIG. 10 is a perspective view of the door and hinge assembly shown in FIG. 8 with the hinge assembly in the extended position and the door decoupled and removed from the hinge assembly.

FIG. 11 is a perspective view of a portion of the hinge assembly shown in FIG. 8, with the hinge assembly in the retracted position.

FIG. 12 is a side view of the portion of the hinge assembly shown in FIG. 11, with the hinge assembly in the extended position.

FIG. 13 is an enlarged cross-section view of the portion of the gaming device shown in FIG. 7.

FIG. 14 is a perspective view of an alternative hinge assembly for use with the gaming device shown in FIG. 4, with the hinge assembly in a retracted position.

FIG. 15 is another perspective view of the hinge assembly shown in FIG. 14.

FIG. 16 is a perspective view of a portion of the hinge assembly shown in FIG. 14, with the hinge assembly in an extended position.

FIG. 17 is a perspective view of an alternative hinge assembly for use with the gaming device shown in FIG. 4, with the hinge assembly in a retracted position.

FIG. 18 is a perspective view of a hinge body of the hinge assembly shown in FIG. 17.

FIG. 19 is an exploded view of the hinge body shown in FIG. 18.

### DETAILED DESCRIPTION

The systems and methods described herein include a gaming device that includes a cabinet defining an internal cavity and a door sized to cover at least a portion of the internal cavity. A hinge assembly removably couples the door to the cabinet. The hinge assembly includes a hinge body having a first section pivotably coupled to the cabinet and a second section connected to the first section that defines a slot for receiving at least a portion of the door therein. As a result, the hinge assembly is able to: (1) secure the door in a closed position, with a bottom of the door being positioned adjacent a footrest of the gaming device, and (2) provide a mechanism for opening the door above and outward of the footrest. For example, if an operator needs to access the internal cavity, the operator may first unlock a latch on the door and allow the door to fall along a path, guided by rotation of the hinge assembly, that opens the door outward from a lower end of the door, without a travel path of the door being obstructed by the footrest. Additionally, the slot defined in the hinge body may receive a portion of the door, such as a pin in a bracket of the door, to secure the door on the hinge, while allowing for a toolless separation of the door from the hinge assembly when the door is in the open position.

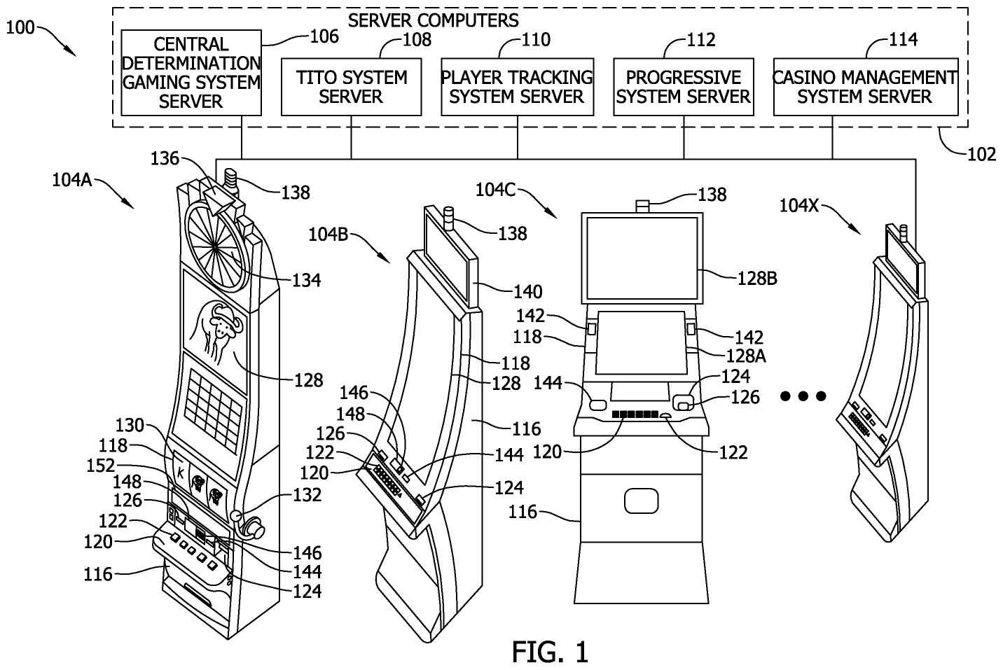

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, and/or total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

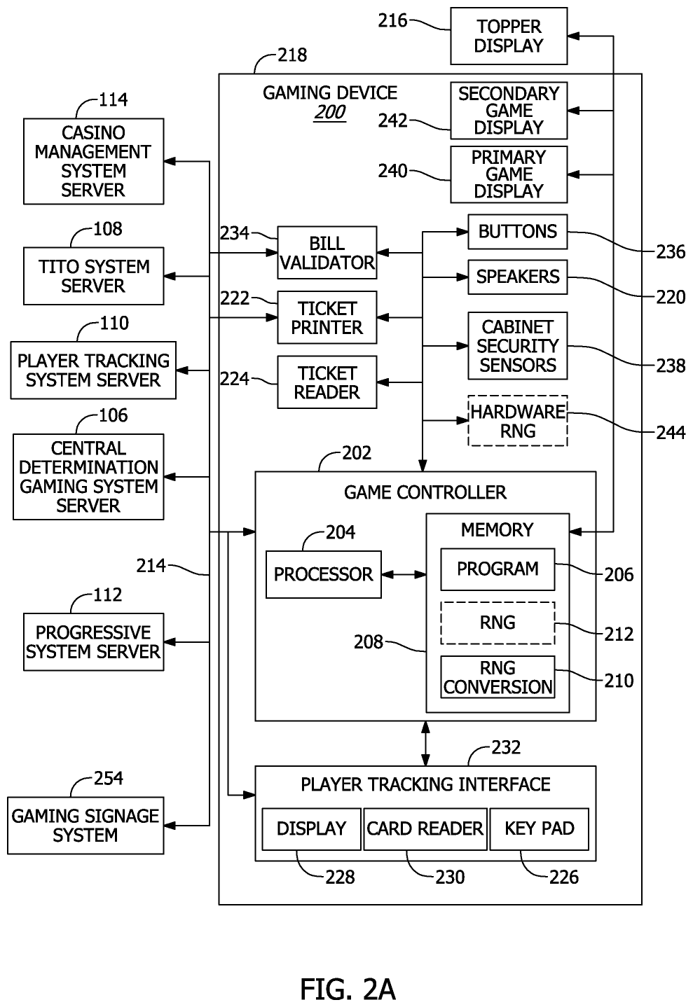

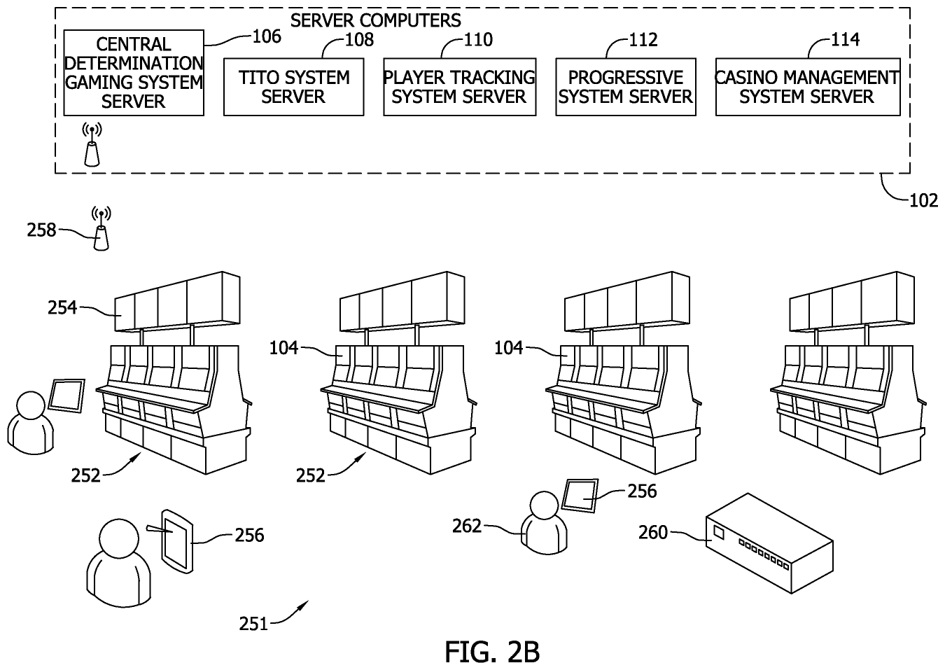

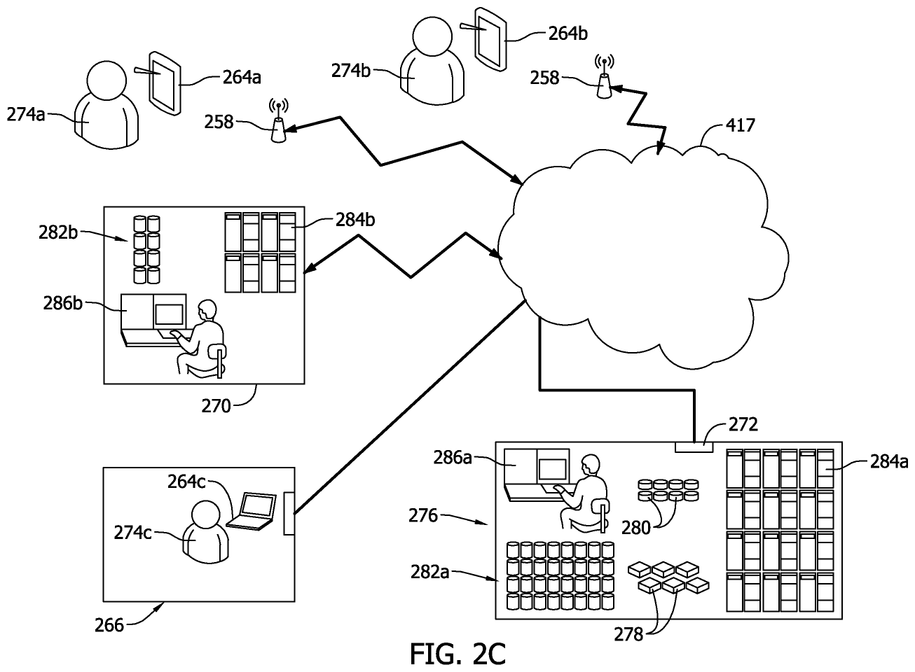

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

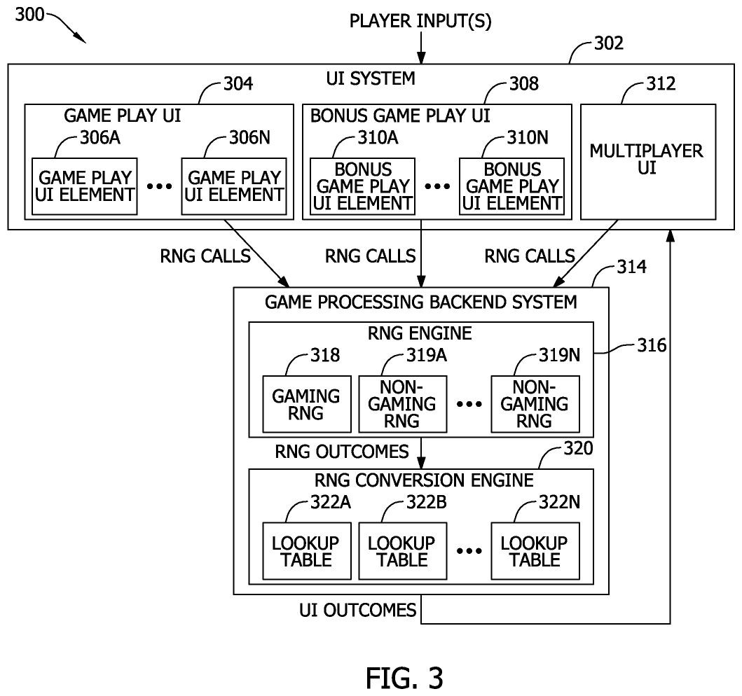

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

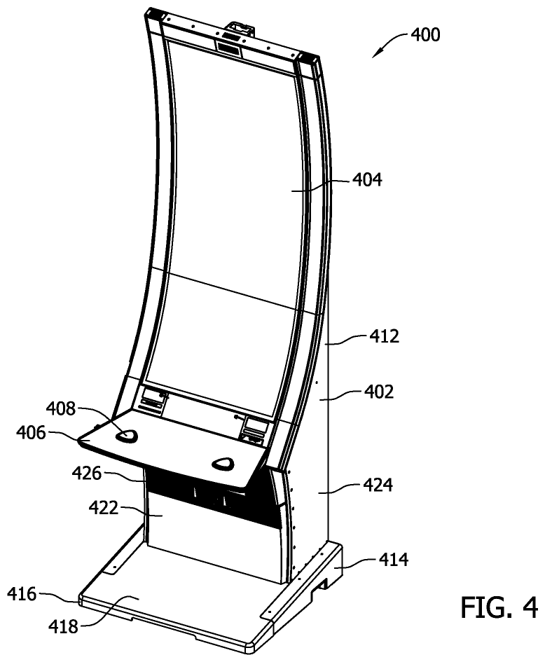

FIGS. 4-6 depict an example gaming device 400, which in some embodiments, may be an implementation of gaming devices 104A-104X described with respect to FIG. 1.

As shown in FIG. 4, the electronic gaming device or “gaming device” 400 includes a cabinet 402 and a display 404 coupled to the cabinet 402, which may display a gaming interface to a user. The gaming device 400 may further include a button deck 406 including one or more buttons 408 that may be used for interacting with gaming device 400.

The cabinet 402 includes a housing 412 and a base 414. The housing 412 is coupled to and supports the display 404 and button deck 406. The base 414 is provided at a bottom of the cabinet 402 and below the housing 412. A footrest 416 is coupled to the cabinet 402 at the base 414. The base 414 extends laterally outward from the housing 412, providing an increased profile of the cabinet 402 at ground level (not shown) for supporting the housing 412 and display 404. The footrest 416 provides a generally inclined and planar surface 418 laterally spaced from the cabinet 402 to allow a user to rest their feet on the footrest 416 during game play.

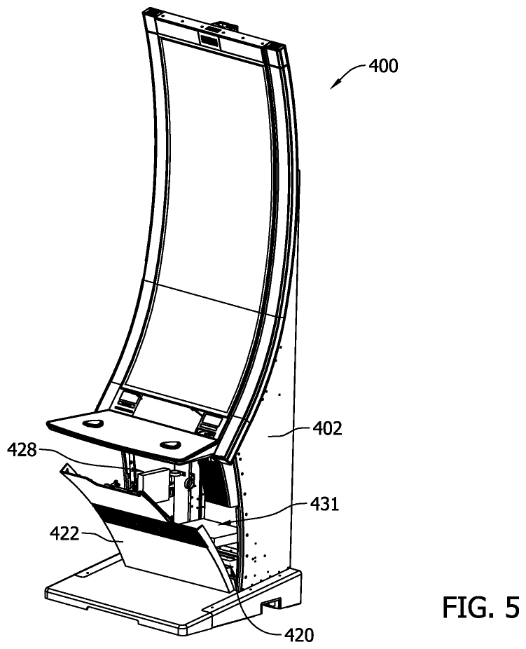

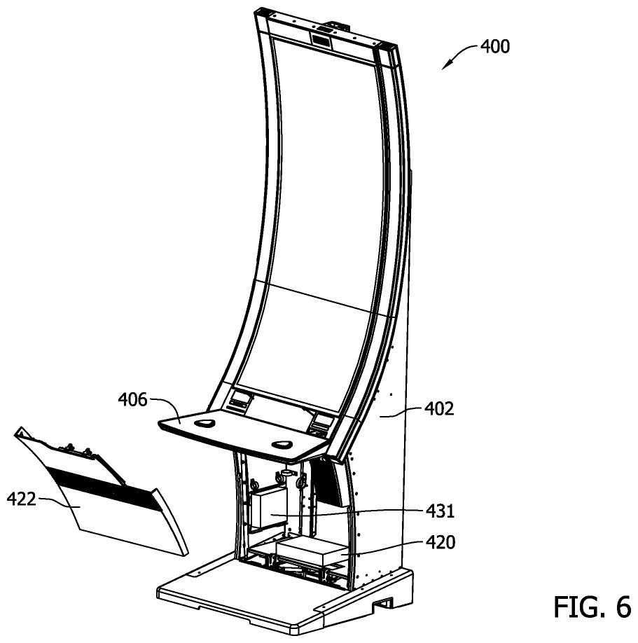

The housing 412 defines an internal cavity 420 (shown in FIGS. 5 and 6), and contains internal components of gaming device 400 such as, for example, bill validator 124 and/or printer 126 (shown in FIG. 2A). A main door 422, also referred to as a “belly door” or “service door”, is coupled to the cabinet 402 and is configured to be selectively opened to provide access to the internal cavity 420. Main door 422 is typically used by service personnel to refill ticket-out printer 126 and collect bills and tickets inserted into bill validator 124. Main door 422 may further be accessed to reset the machine, verify and/or upgrade the software, and for general maintenance operations. In the example embodiment, main door 422 is coupled to a front side of the cabinet 402 at a position below the button deck 406 and above the footrest 416. Main door 422 extends laterally across the cabinet 402 from a first sidewall 424 of the cabinet 402 to a second, opposed, sidewall 426 of the cabinet 402. In other embodiments, the main door 422 may be located at any suitable position on cabinet 402.

In the example embodiment, main door 422 is hingedly coupled to cabinet 402 to facilitate rotating main door 422 relative to cabinet 402 between a closed position, as shown in FIG. 4, and an open position, as shown in FIG. 5. Referring to FIG. 5, in the open position, an opening 428 is defined between main door 422 and cabinet 402 to provide access to internal EGM components 431 located within internal cavity 420. In the open position of FIG. 5, an operator may access the internal EGM components 431 to perform general service operations, such as resetting game device 400.

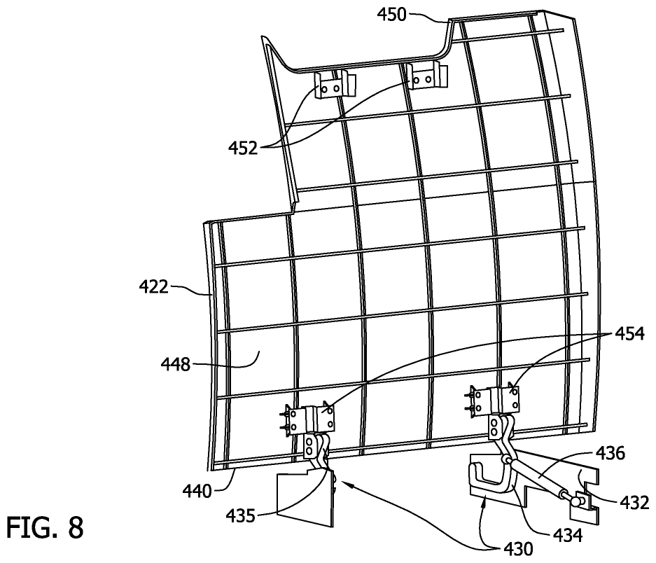

Main door 422 is further releasably coupled to cabinet 402 to facilitate removing main door 422 from cabinet 402 to provide increased access to the internal cavity 420, relative to the open position shown in FIG. 5. For example, referring to FIG. 6, the main door 422 is shown detached from the cabinet 402 to provide full access to the cavity 420. Full access to the cavity 420 may enable the performance of additional servicing operations on the gaming device 400 that are not accessible when the main door 422 is the open position, but not removed from the cabinet 402. To remove the main door 422, the main door 422 is first unlatched, as described in greater detail with respect to FIG. 8 and rotated to the open position, shown in FIG. 5. With the main door 422 in the open position, the main door 422 may be lifted off the hinge and outward, clear of the button deck 406, separating the main door 422 from the cabinet 402.

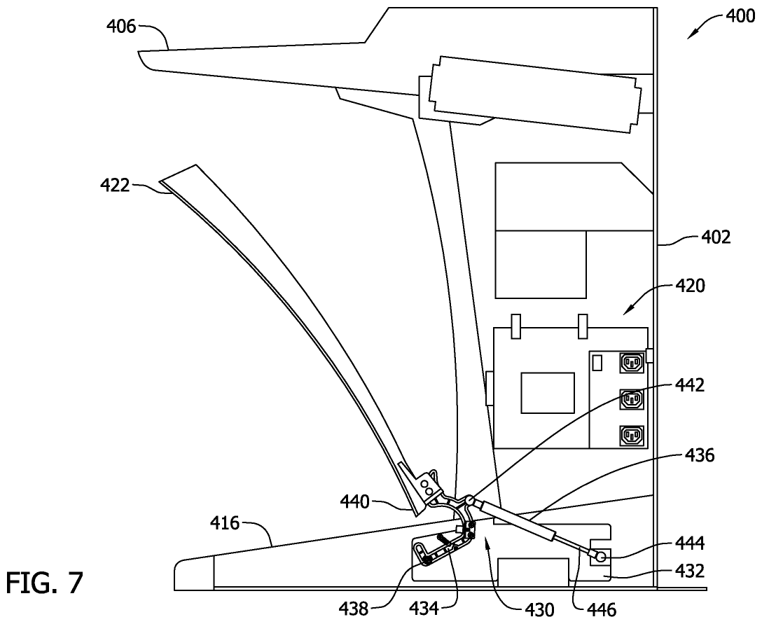

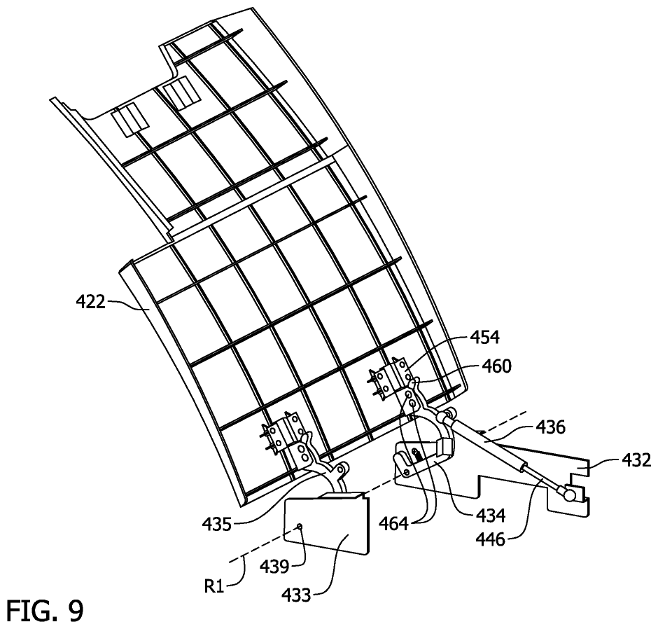

FIG. 7 is a cross sectional view of a portion of the gaming device 400 shown in FIGS. 4-6, showing the main door 422 in the open position. In the example embodiment, gaming device 400 includes a hinge assembly 430 coupling the main door 422 to the cabinet 402. The hinge assembly 430 is pivotably coupled to a cabinet bracket 432 of the gaming device 400. The cabinet bracket 432 is fixed to the cabinet 402 (e.g., such as by fasteners). The hinge assembly 430 includes a hinge body 434 and a damper 436 coupled to the hinge body 434. The hinge body 434 is pivotably coupled to cabinet bracket 432 by a pivot pin 438. The hinge body 434 is further configured to rotate about a rotational axis R₁ (shown in FIG. 9) extending into the pivot pin 438 (i.e., into the page in FIG. 7), to rotate the door 422 between the open and closed positions, shown in FIGS. 5 and 4 respectively.

In the example embodiment, the pivot pin 438 is positioned below the main door 422 and the footrest 416. The hinge body 434 extends inward from the pivot pin 438 from the footrest 416 and into the internal cavity 420 of the cabinet 402. In the open position, as shown in FIG. 7, the hinge body 434 further extends outward of the cabinet 402. As a result, the hinge body 434 allows for upward and outward movement of the door 422, when moved from the closed position to the open position, to lift a lower end 440 of the door 422 above the footrest 416, providing an increased range of motion of the door 422 and reducing interference with the footrest 416 as the door 422 is moved.

The hinge assembly 430 further includes a damper 436 coupling the hinge body 434 to the cabinet 402. The damper 436 includes a first end 442 pivotably coupled to the hinge body 434 and a second, opposed end 444, pivotably coupled to the cabinet 402, or more specifically, the cabinet bracket 432. The damper 436 includes a piston 446 which defines the second end 444 and is pivotably coupled to the cabinet 402, wherein the second end 444 may be operatively connected to a portion of the cabinet bracket 432 that extends out from the plane of the remaining portion of the cabinet bracket 432 (shown in FIG. 7 and FIG. 9). The damper 436 resists sudden sharp movements of the piston 446 to provide a “soft opening” of the door 422. In particular, in the example embodiment, the damper 436 is a viscous damper that contains a fluid therein resisting motion of the piston 446. In other words, in the example embodiment, the damper 436 does not bias the hinge body 434 and/or the main door 422 but does provide a resistance force to movement of the door 422 when opening to resist the natural gravitational tendency of the door 422 to sharply fall open. In other embodiments, any suitable damper 436 may be used. Moreover, in some embodiments, hinge assembly 430 does not include the damper 436.

FIGS. 8-10 show the main door 422 and binge assembly 430 of the gaming device 400, with other portions of the gaming device 400 being removed. Referring to FIG. 8, the main door 422 is shown in the closed position and the hinge assembly 430 is shown in a retracted position. The main door 422 includes an inner surface 448 which extends from a lower end 440 of the door 422 to an upper end 450 of the door 422. The door 422 includes a pair of latch brackets 452 coupled to the inner surface 448 and extending inward therefrom. When the door 422 is in the closed position, a key latch (not shown) of the cabinet 402 engages the latch brackets 452 to lock the door 422 in the closed position. The key latch may be turned (e.g., by use of a key) to disengage the latch brackets 452 and allow the door 422 to be moved to the open position (shown in FIG. 9). In the example embodiment the latch brackets 452 are positioned proximate the upper end 450 of the main door 422, though in other embodiments, the latch brackets 452 may be positioned at any suitable location on the door 422.

In the example embodiment, the main door 422 further includes a pair of door brackets 454 coupled to the inner surface 448 and extending inwardly of the door 422 (i.e., into the cavity 420) therefrom. The door brackets 454 are positioned adjacent to the lower end 440 of the main door 422 and are laterally spaced from one another.

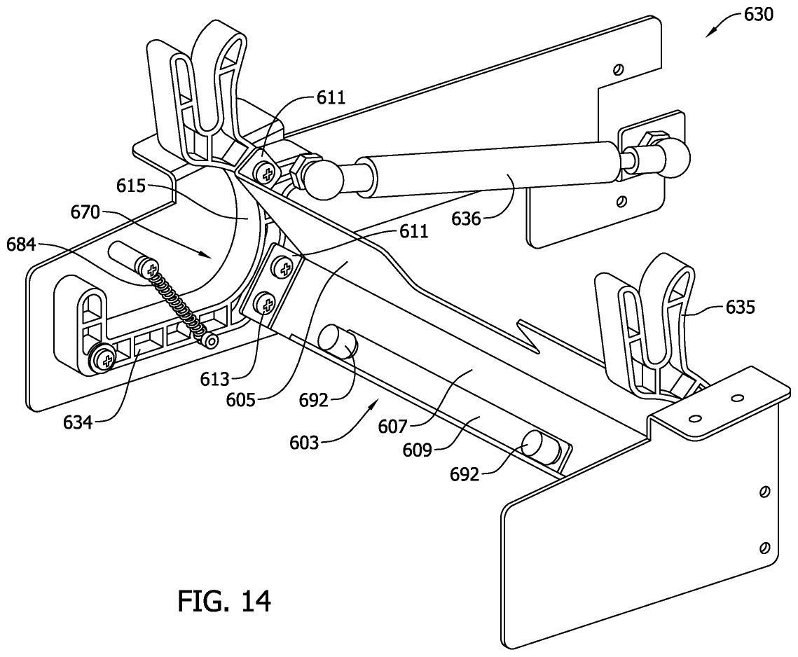

The hinge assembly 430 includes a pair of hinge bodies 434, 435 with each of the hinge bodies 434 being positioned in alignment with a respective one of the door brackets 454. In the example embodiment, the second hinge body 435 is substantially the same as the first hinge body 434, except that the second hinge assembly 435 does not include a damper 436 coupled to the hinge body 435. For example, as shown in FIG. 9, the second hinge body 435 extends from a second pivot pin 439 coupled to a second cabinet bracket 433. In some embodiments, first and second hinge bodies 434, 435 may be coupled or attached to one another and/or otherwise formed as a single piece. For example, in some embodiments, gaming device 400 includes a hinge plate or hinge connection bracket 603 (shown in FIGS. 14-16) that is attached to the hinge bodies 434, 435 of and extends from the first binge body 434 to the second hinge body 435.

Referring to FIG. 9, in the example embodiment, when door 422 is in the open position, hinge bodies 434, 435 are each rotated in a first direction (e.g., counterclockwise in the view of FIG. 9) about the rotational axis R₁ from the retracted position shown in FIG. 8 to an extended position. That is, in the example embodiment, both hinge bodies 434, 435 rotate about rotational axes that are colinear. In other embodiments, the rotational axes of the hinge bodies 434, 435 may be offset from one another. Moreover, when the door 422 is in the open position, the piston 446 of the damper 436 is moved to an extended position, as shown in FIG. 9. The pivotable coupling of the damper 436 to the cabinet bracket 432 and the hinge body 434 allows the damper 436 to pivot upward with the hinge body 434 as the door 422 is moved to the closed position.

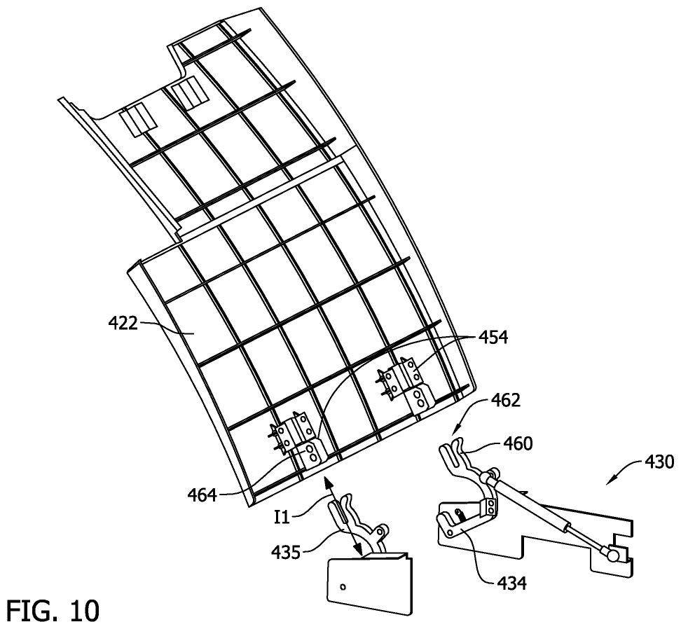

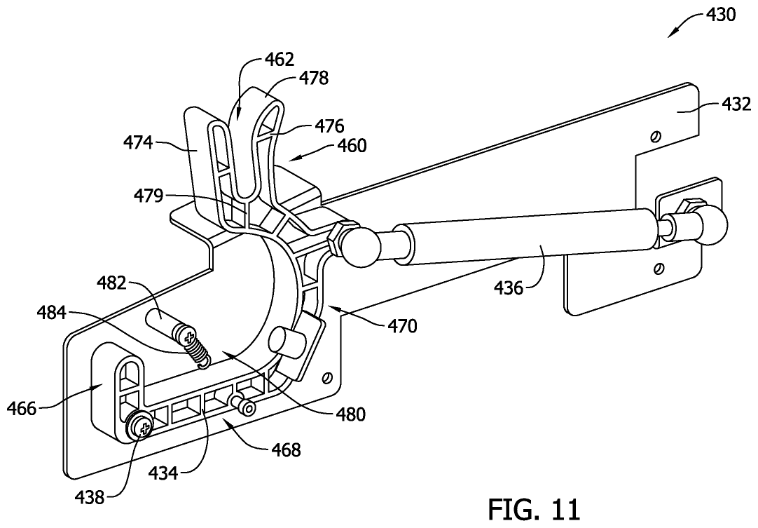

In the example embodiment, main door 422 is coupled to the hinge bodies 434, 435 by a slide-in pin interface. Specifically, hinge bodies 434, 435 each include a fork section 460 that each define a respective slot 462 (shown in FIG. 11) therein. Each of the door brackets 454 further include a pair of laterally extending pins 464 which are sized to be received within the slots 462 of the fork sections 460. The door brackets 454; pins 464; and hinge bodies 434, 435 are each positioned in alignment with one another to facilitate sliding the pins 464 into the respective fork sections 460 of hinge bodies 434, 435 simultaneously. When the door 422 is in the open position, as shown in FIG. 9, the door 422 may be decoupled from the hinge bodies 434, 435, and the cabinet 402 more broadly, by sliding the door 422 along an installation direction I₁, as shown in FIG. 10.

Referring to FIG. 10, the installation direction I₁ is generally parallel to the slots 462 of the fork sections 460. Additionally, the shape of the slots 462 and the position of the hinge bodies 434, 435 when the door is in the open position, facilitate “slide-out” and “toolless” removal and installation of the door 422, without interference from the button deck 406, shown in FIG. 6. That is, the door 422 may be slid out along the installation direction I₁, and will be outward of the button deck 406 while the pins 464, which extend from the door brackets 454, are in the slots 462. Once the pins 464 have cleared the fork sections 460, the door 422 may be entirely removed and positioned separate from the cabinet 402 for performing servicing operations on internal components 431 (shown in FIG. 6) within the internal cavity 420.

As described in greater detail with respect to FIGS. 11-13, the hinge assembly 430 provides a biasing force on the door 422 to bias the door 422 to the open position when the door 422 is removed, as shown in FIG. 10. To reinstall the door 422, the door 422 is guided along the installation direction I₁, aligning the pins 464 of the door brackets 454 with the slots 462 defined in the fork sections 460, until the pins 464 are seated within the slots 462. The door 422 may then be pushed inward (i.e., to the right of the page in FIG. 10), to rotate the hinge bodies 434, 435 and move the door 422 to the closed position.

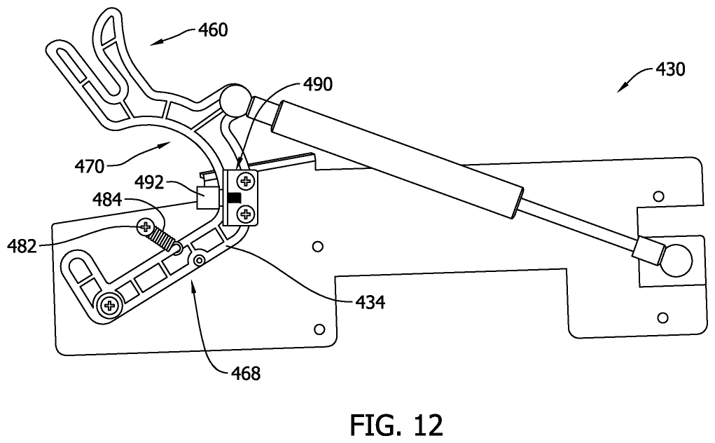

FIG. 11 shows the hinge assembly 430 when the door 422 (shown in FIG. 9) is in the closed position. FIG. 12 shows the hinge assembly 430 when the door 422 is in the open position.

Referring to FIG. 11, in the example embodiment, the hinge body 434 includes a radial section 468 (also referred to herein as a “first section:), the fork section 460 (also referred to herein as a “second section”), an arced section 470 (also referred to herein as a “third section”) extending between and connecting the radial section 468 to the fork section 460, and a tail section 466. The radial section 468 extends linearly or “radially” from the pivot pin 438 to the tail section 466 and the arced section 470. The arced section 470 is curved or “arced” and extends from the radial section 468 to the fork section 460. In the example embodiment, the arced section 470 extends along an are subtending an angle of approximately 180 degrees. The damper 436 is pivotably coupled to the hinge body 434 at the arced section 470. The tail section 466 also extends radially from the pivot pin 438 and is oriented generally perpendicular to the radial section 468, thereby forming, for example, an L-shaped configuration at the pivot pin 438. The tail section 466 is sized to engage a cabinet stop (not shown) coupled to the cabinet 402 to limit rotational movement of the hinge body 434 inward (i.e., clockwise in the view of FIG. 11) from the closed position.

The fork section 460 extends generally radially of the arced section 470 and outwards or away from both the arced section 470 and the radial section 468. The fork section 460 includes a pair of arms 474, 476 that define the slot 462 therebetween for receiving the pins 464 of the door brackets 454 (shown in FIG. 10). The pair of arms 474, 476 may be: (1) a first arm (i.e., arm 474) that generally extends linearly; and (2) a second arm (i.e., arm 476) that includes a flared tip end 478. The flared tip end 478 flares outwards from the arm 474 such that the slot 462 has an increased width proximate the distal ends of the arms 474, 476 than at a base 479 of the fork section 460. The flared tip 478 of the arm 476 provides a guide for inserting the door pins 464 into the slots 462. In the example embodiment, the hinge body 434 is formed by a die casting of a rigid material, such as a polymer or metal material. In other embodiments, hinge body 434 may be formed of any suitable material.

In the example embodiment, hinge assembly 430 further includes a spring assembly 480 which provides a biasing force on the hinge body 434 to bias hinge body outward (as shown in FIG. 12), when the door 422 is decoupled from the hinge assembly 430. The spring assembly 480 includes a strut 482 attached to the cabinet bracket 432 and a spring 484 attached to the strut 482. The strut 482 is positioned between the tail section 466 and the arced section 470 of the hinge body 434 and generally above the radial section 468, when the hinge assembly 430 is in the retracted position, as shown in FIG. 11.

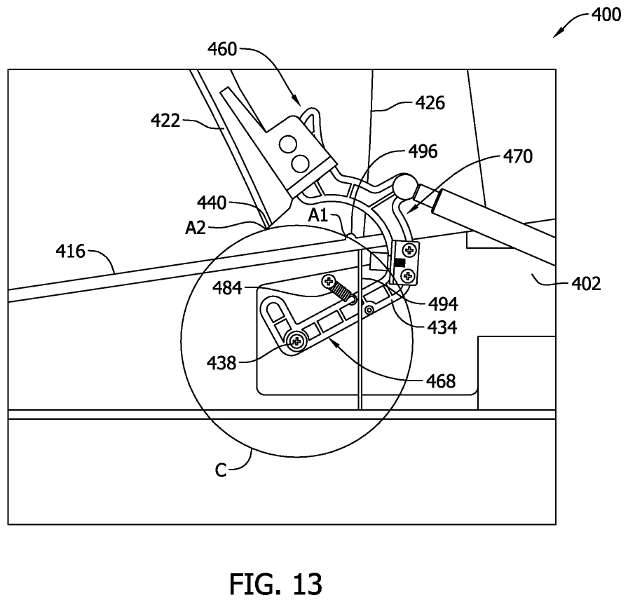

The spring 484 extends from the strut 482 and engages the hinge body 434 at the radial section 468. Although FIG. 11 shows the spring hanging loosely off the strut 482, the spring 484 extends to and engages the radial section 468, to apply the biasing force to the binge body 434, as shown in FIGS. 12 and 13 for example. In some embodiments, the spring 484 engages a radial pin 488 provided on the radial section 468. In other embodiments, the spring 484 is directly attached to the radial section 468, as shown in FIGS. 12 and 13. In the example embodiment, the spring 484 is a tension spring and provides the biasing force on the radial section radially inward toward the strut 482. As a result, when the hinge assembly 430 is in the extended position, as shown in FIG. 12, the spring 484 biases the radial section 468 inward toward the strut 482, leaving the fork section 460 positioned outward to receive the door 422 for installation. In other embodiments, spring assembly 480 may include any other suitable spring or biasing device more broadly.

Referring to FIG. 12, in the example embodiment, hinge assembly 430 further includes an open stop 490 coupled to the arced section 470. The open stop 490 extends laterally from the arced section (i.e., out of the page in the view of FIG. 12). The open stop 490 includes a cushioned bumper 492 which is positioned to contact the cabinet 402, as shown in FIG. 13, when the hinge assembly 430 is in the extended position to limit further rotational movement (e.g., in the counterclockwise direction) of the hinge body 434 from the open position.

FIG. 13 shows a portion of the gaming device 400 with the door 422 in the open position. In the example embodiment, the open stop 490 is in contact with the cabinet 402 at an end wall 494 of the cabinet 402 proximate the footrest 416. As shown in FIG. 13, the pivot pin 438 is positioned directly beneath the footrest 416, with the radial section 468 extending obliquely from the pivot pin 438 to the arced section 470, and the arced section curving within the cabinet 402 and beyond the sidewalls 424, 426 (shown in FIG. 4) of the cabinet 402 to the fork section 460. As a result, the hinge body 434 provides a rotational travel path of the door 422 indicated by the circle at C from the position A: when the door 422 is in the closed position, to the position A₂ when the door is in the open position, such that the hinge body 434 can rest against a protruding shelf or screw within a base of the footrest 416. The footrest 416 further includes a slit bump 496 proximate the cabinet 402. When in the closed position, the lower end 440 of the door 422 is positioned at the point on the arc indicated at A₁ and outward of the slit bump 496. The slit bump 496 provides an obstruction to prevent tampering with the gaming device 400 through the insertion of any tools or small objects through a slit (not shown) defined between the door 422, the footrest 416, and the cabinet 402 when the door 422 is in the closed position.

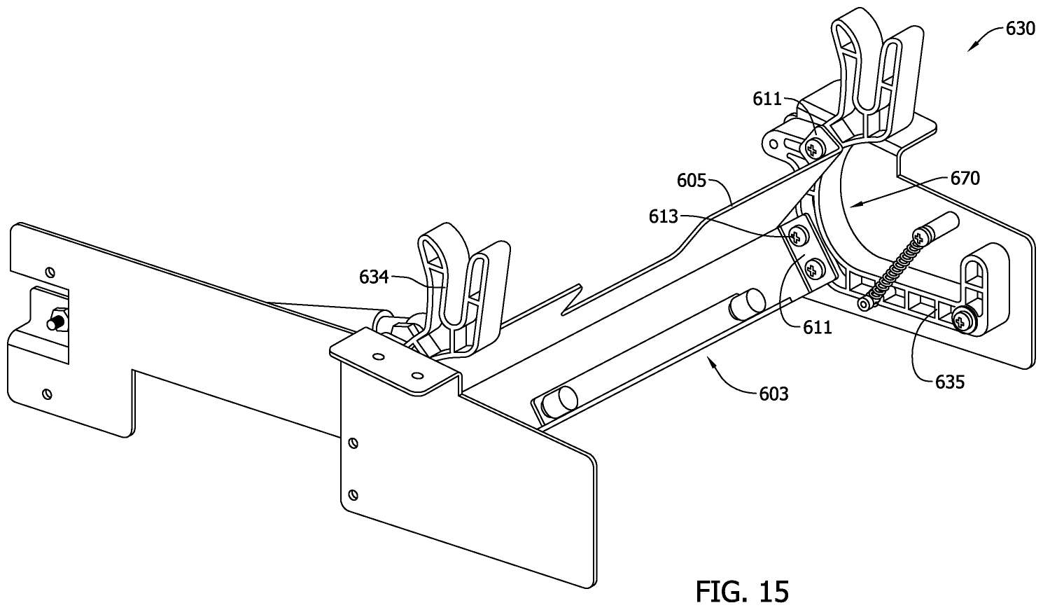

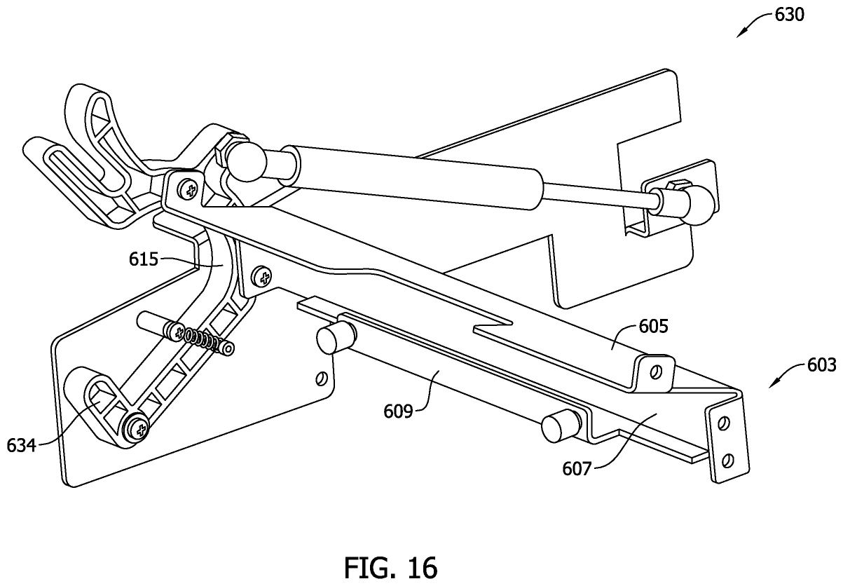

FIGS. 14-16 show an alternative embodiment of a hinge assembly 630 for use with the gaming device 400 of FIG. 4. FIGS. 14 and 15 show the hinge assembly 630 in the retracted position. FIG. 16 shows a portion of the hinge assembly 630 (not including the hinge body 635) in the extended position. The binge assembly 630 is substantially the same as the hinge assembly 430 described with respect to FIGS. 7-13 except as described differently herein.

In particular, referring to FIG. 14, the hinge assembly 630 further includes a hinge connection bracket 603 that is coupled to hinge bodies 634, 635, and which extends laterally across the hinge assembly 630 between the hinge bodies 634, 635. The hinge connection bracket 603 is (1) operatively combining the hinge bodies 634, 635 to reduce or remove dangling effects associated with instances where a damper (e.g., damper 636) is present on a first side but not on a second, opposing side; (2) transferring forces between the hinge bodies 634, 635 to resist against independent movement of one of the hinge bodies 634, 635 relative to the other of the hinge bodies 634, 635. As a result, the hinge connection bracket 603 provides support against tampering or twisting of the door 422 (shown in FIG. 13) or other destabilizing events, such as dangling effects, by resisting against independent movement of the hinge bodies 634, 635.

The hinge connection bracket 603 includes a first plate 605, a second plate 607, and a bumper plate 609. The bumper plate 609 includes a pair of laterally spaced bumpers 692 which contacts the cabinet 402 (shown in FIG. 7) when the hinge assembly 630 is in the extended position in substantially the same manner as described above with respect to bumper 492. The second plate 607 extends between the first plate 605 and the bumper plate 609.

As shown in FIG. 16, the first plate 605 extends obliquely away from the second plate 607 and the bumper plate 609 extends generally transversely from the second plate 607. The connection bracket 603 is shaped to have an overall lateral profile that is substantially positioned radially outward of inner surfaces 615 of the hinge bodies 634, 635 and such that the connection bracket 603 does not obstruct movement or interfere with the cabinet 402 during movement of the hinge assembly 630 between the extended and retracted positions.

As shown in FIGS. 14 and 15, the hinge connection bracket 603 is fixedly attached to the hinge bodies 634, 635 at the arced sections 670. The first plate 605 and the second plate 607 each include a pair of side flaps 611 (shown in FIG. 16) at opposed lateral ends of the connection bracket 603 for attaching the connection bracket 603 to the hinge bodies 634, 635. Fasteners 613 extend through the respective side flaps 611 and into the arced sections 670 of the binge bodies 634, 635. In other embodiments, the hinge connection bracket 603 may be coupled to the hinge bodies 634, 635 in any suitable manner. For example, in some embodiments, the connection bracket 603 is welded or unitarily formed with the hinge bodies 634, 635.

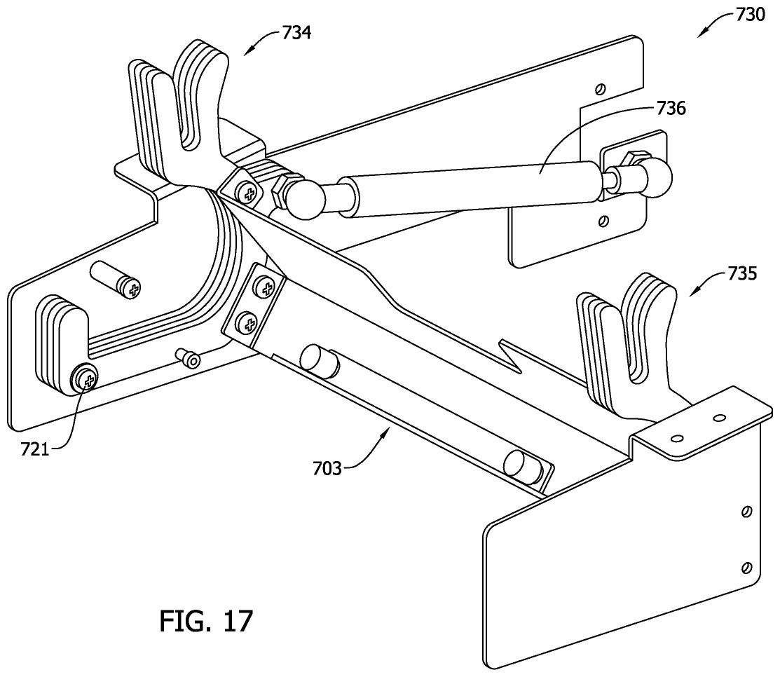

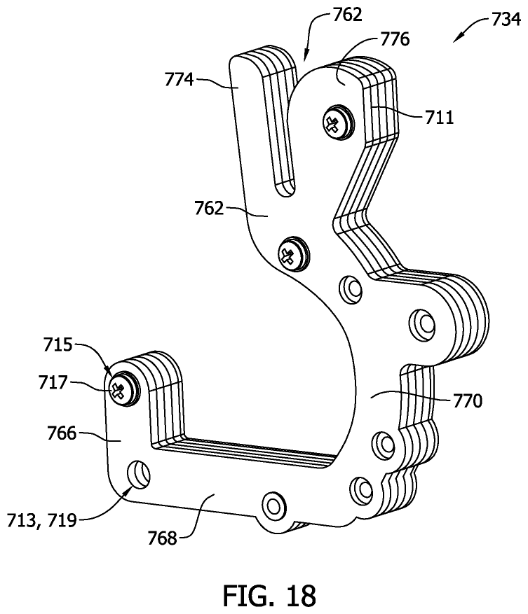

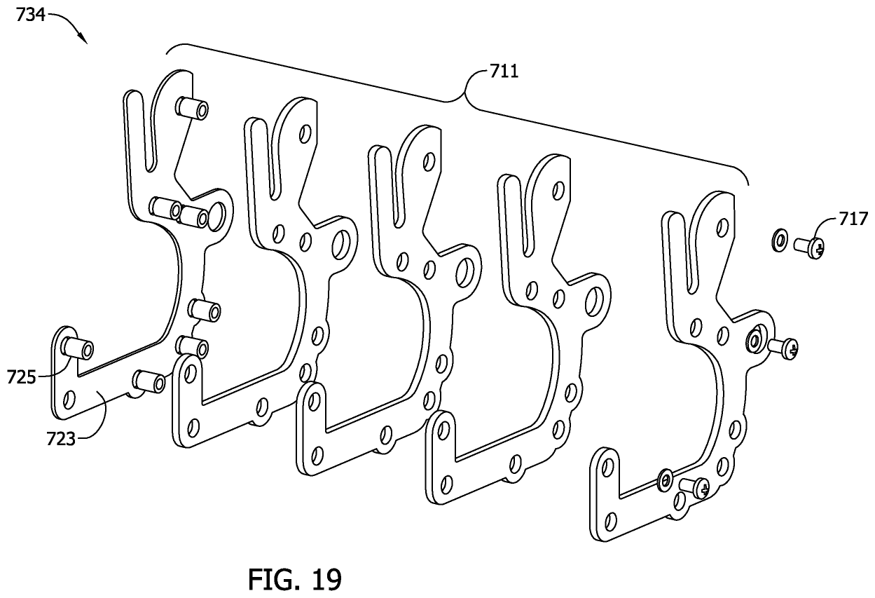

FIG. 17 shows an alternative embodiment of a hinge assembly 730 for use with the gaming device 400 of FIG. 4. FIG. 18 shows a hinge body 734 of the alternative hinge assembly 730. FIG. 19 shows an exploded view of the hinge body 734. The hinge assembly 730 is substantially the same as the hinge assembly 430 described with respect to FIGS. 7-13, and the hinge assembly 630 described with respect to FIGS. 14-16, except as described differently herein.

In particular, referring to FIG. 17, the hinge assembly 730 includes a pair of hinge bodies 734, 735 that are connected to a hinge connection bracket 703 in substantially the same configuration as hinge assembly 630, described in FIG. 14. The hinge bodies 734, 735 are substantially identical to one another and each have a substantially similar shape as hinge bodies 434, 435, 634, and 635. Hinge body 734 includes a tail section 766, a radial section 768, an arched section 770, and a fork section 760. The fork section 760 includes a first arm 774 and a second arm 776 that define a slot 762 therebetween. However, in contrast with hinge bodies 434 and 634, which are formed as a single piece cast, in the example embodiment, hinge body 734 is formed of a plurality of stacks 711 that are overlayed and coupled to one another to form the hinge body 734.

In the example embodiment, each of the stacks 711 has a substantially identical shape and define a plurality of apertures 713 defined therein. A first subset 715 of apertures 713 receive one of a first set of fasteners 717 therein for mechanically coupling the stacks 711 to one another. A second subset 719 of apertures receive one of a second set of fasteners 721 (shown in FIG. 17) which are used to couple hinge body 734 to other features of hinge assembly 730 and/or cabinet 402, such as connection bracket 703 and damper 736. In the example embodiment, each of the first subset 715 and second set 719 of fasteners are threaded screws, though in other embodiment any suitable fasteners may be used.

Referring to FIG. 19, in the example embodiment, hinge body 734 includes five stacks 711, though in other embodiments, hinge body 734 may include any suitable number of stacks 711. A first stack 723 includes a plurality of fastener mounts 725 thereon. Fastener mounts 725 are fixed to first stack 723 and include internal threads (not shown) that mate with external threads (not shown) provided on fasteners 717, 719. During assembly each stack 711 is stacked on to first stack 723 such that fastener mounts 725 extend through corresponding apertures of subsequent stacks 711. In the example embodiment, each of the stacks 711 are formed of a steel sheet metal, though in other embodiments, other suitable materials may be used.

In the example embodiment, the hinge bodies 734, 735 may provide improved resilience against deformation under bending moments. For example, referring back to FIG. 7, the door 422 extends from the hinge body 434 distally toward the button deck 406 when the door 422 is in the open position. Accordingly, forces on a distal end of the door 422 may apply a relatively large bending moment on hinge 434. In the embodiment of FIG. 17, the hinge body 734 may provide an increased resistance to deformation under such bending moments.

Exemplary technical effects of the methods, systems, and apparatus described herein include at least one of: (a) providing a removal mechanism for opening and removing a main door from a cabinet of a gaming device; (b) improved opening of a door of a gaming device by providing a damper and hinge assembly that enable a soft opening of the door from a closed position; (c) improved separation of a door of a gaming device by providing a hinge assembly that engages the door and enables toolless separation of the door from the hinge assembly; (d) improved accessibility to areas of a gaming device; (e) improved serviceability of a gaming device; (f) reduced overall time required in servicing, installation, and/or removal of a main door from a gaming device; and (i) improved tamper prevention by providing a pair of hinge assemblies to limit twisting of the door and a slit pump to resist against insertion of foreign objects between the door and the cabinet when the door is in a closed position.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming device comprising:
a cabinet defining an internal cavity therein;
a door sized to cover at least a portion of the internal cavity; and
a hinge assembly removably coupling the door to the cabinet, the hinge assembly comprising a hinge body, wherein the hinge body comprises a first section coupled to the cabinet by a pivot coupling and extending radially outward from the pivot coupling, the hinge body further comprising a second section connected to the first section, wherein the second section contains a slot for receiving at least a portion of the door therein.

2. The gaming device of claim 1 further comprising a damper pivotably coupled to the hinge body and the cabinet, the damper being configured to provide a resistance force on the hinge as the door is moved from a closed position to an open position.

3. The gaming device of claim 1, wherein the hinge assembly rotates the door along an arc between a closed position, in which the door is positioned to contact the cabinet, and an open position, in which the door is spaced from the cabinet to provide access to the internal cavity.

4. The gaming device of claim 3, wherein the door includes a pin sized to be received within the slot of the second section, and wherein, when the door is in the open position, the door is configured to be separated from the cabinet by lifting the pin out of the slot of the second section.

5. The gaming device of claim 1, wherein the second section further comprises a first arm and a second arm, whereby the first arm and the second arm are separated by the slot, thereby defining the slot within the second section.

6. The gaming device of claim 5, wherein the first arm extends in a linear direction and the second arm contains a flared tip.

7. The gaming device of claim 1, wherein the hinge body further comprises a third section, wherein the third section is curved and extends between the first section and the second section.

8. The gaming device of claim 7, wherein the third section extends along an arc subtending an angle of approximately 180 degrees.

9. The gaming device of claim 1, wherein the first section is operatively connected to a strut via a spring.

10. The gaming device of claim 9, wherein the spring is a tension spring.

11. The gaming device of claim 9, wherein the spring biases the first section toward to the strut, thereby positioning the second section in an outward direction.

12. The gaming device of claim 1, wherein the hinge assembly further comprises:
an additional hinge body pivotably coupled to the cabinet; and
a hinge connection bracket coupled to the hinge body and the additional hinge body.

13. The gaming device of claim 1, wherein the hinge body is formed of a plurality of stacks layered on top of one another, the plurality of stacks being fastened to one another to form a single piece hinge body.

14. A hinge assembly for removably coupling a door to a cabinet of a gaming device, the hinge assembly comprising:
a pivot coupling; and
a hinge body comprising:
a first section configured to be coupled to the cabinet by the pivot coupling, the first section extending radially outward from the pivot coupling; and
a second section connected to the first section, wherein the second section contains a slot sized to receive at least a portion of the door therein.

15. The hinge assembly of claim 14, wherein the second section further comprises a first arm and a second arm, whereby the first arm and the second arm are separated by the slot, thereby defining the slot within the second section.

16. The hinge assembly of claim 15, wherein the first arm extends in a linear direction and the second arm contains a flared tip.

17. The hinge assembly of claim 14, further comprising a third section, wherein the third section is curved and extends between the first section and the second section.

18. The hinge assembly of claim 17, wherein the third section extends along an arc subtending an angle of approximately 180 degrees.

19. A method of removably coupling a door to a cabinet of a gaming machine, the method comprising:
positioning a hinge assembly to face exterior to the cabinet, the hinge assembly including a hinge body including a first section coupled to the cabinet by a pivot coupling and extending radially outward from the pivot coupling, the hinge body further including a second section connected to the first section, wherein the second section contains a slot;
sliding the door into the slot; and
pivoting the door to rotate the hinge body and close the door on the cabinet.

20. The method of claim 19, wherein the hinge body farther includes a third section, the third section being curved and extending between the first section and the second section.
